(19) United States
(12) Patent Application Publication
(10) Pub. No.: US 2016/0120159 A1
(43) Pub. Date: May 5, 2016

(54) FISHING LURE

(71) Applicant: Sergiy TSYBULNYK, Burnaby (CA)

(72) Inventor: Sergiy TSYBULNYK, Burnaby (CA)

(21) Appl. No.: 14/895,891

(22) PCT Filed: Jun. 4, 2013
(86) PCT No.: PCT/CA2013/000542

§ 371 Date: Dec. 3, 2015

(51) Int. Cl. A01K 85/00

(52) U.S. Cl. CPC A01K 85/00

(57) ABSTRACT

A fishing lure that is dually operational for self-propelled movement or manual manipulation through the water to mimic the natural movement of live fish prey. The fishing lure comprising a watertight body for housing a battery, a controller connected to the battery, a motor connected to the controller, a tail assembly operatively connected to the body by a tail shaft driven by the motor to cause the tail assembly to oscillate and propel the fishing lure through water. In accordance with another aspect, the battery is connected via a controller to a coil, the coil positioned relative to a magnet, said coil oscillating in response to magnetic pole interactions between the coil and the magnet by virtue of a controller defined alternating current passing through the coil. The coil oscillation causing movement of the tail assembly to propel the fishing lure through water.

### FIELD OF THE INVENTION

The present disclosure relates to the field of fishing lures and, in particular, to an interchangeable fishing lure that self-propels through the water to simulate the movement of live bait.

### BACKGROUND OF THE INVENTION

The success of a fishing bait to attract fish will depend on properties such as the lifelike texture, odour and colour of the bait presented. Natural fishing bait such as smaller bait fish, worms, leeches, minnows, frogs, salamanders, and insects, are all commonly used natural bait. Some anglers prefer to use live or dead natural bait to attract predatory fish, however, concerns relating to disease transfer and the risk of contaminating ecosystems through the use of natural bait, have made artificial lures an attractive alternative.

Artificial fishing bait, also called lures, are designed to mimic fish prey. In particular, artificial fishing lures typically have hooks and sometimes appendages on their outer surface designed to cause the bait to wobble, or vibrate, when the bait is drawn through the water. By manually manipulating the presentation and retrieval of the lure through the water, the action of the fishing lure can be controlled by the angler to mimic the movement of fish prey. In this way, it is intended that the lure will attract fish to the bait.

Conventional fishing lures have evolved into a number of different styles designed to resemble fish prey. These include plugs, jigs, spinners, flies, spoons, and others. Spoons, for example, are commonly dish shaped pieces of metal that have a hook which revolves or wobbles as it is drawn through the water due to the curvature of the metal dish. Plugs or spinners are roughly of a fish shape and are typically painted, or patterned, to look like a fish. The plug or spinner includes a lip which is slightly dished and which, on pulling the plug through the water, causes the plug or spinner to wobble so attracting fish to the bait.

Artificial lures exist where the lures at least partially provide for their own movement and in a manner try to mimic a live fish. Examples include self-propelling lures which typically consist of a casing that is assembled around, amongst other things, a battery, a motor and a set of gears which drive the tail of the lure to and fro sideways. While these self-propelled lures rely less on the skill of the angler to manipulate the lure through the water, achieving movement that mimics natural prey has been found to be challenging. Moreover, the movement of a self-propelled lure can be one-dimensional, offering little opportunity for the angler himself to control or vary the movement of the lure.

A common trait of artificial lures, whether the manually manipulated type or the self-propelled type, is that they need to be tied on to the fishing line in a secure manner. While it is typical for anglers to have a preferred style of lure for catching specific prey, it is often desired to change the style of lure being used in order to improve the chances of success. To do so requires the artificial lure to be cut from the line and the new lure tied on. This can be cumbersome and inconvenient.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

Dislosed herein are exemplary embodiments pertaining to a fishing lure. An exemplary embodiment of the present disclosure relates to an interchangeable fishing lure that self-propels through the water to simulate the movement of live bait. In accordance with a further exemplary embodiment, the present disclosure relates to an interchangeable fishing lure that has dual modes between a self-propelled mode and a manual mode.

In accordance with one aspect of the disclosure, there is provided a fishing lure comprising a watertight body for housing a battery for providing electrical energy, a controller connected to the battery, a motor connected to the controller for converting the electrical energy into mechanical energy; a tail assembly operatively connected to one end of the body, the tail assembly connected to the body by a tail shaft driven by the motor to cause the tail assembly to oscillate and propel the fishing lure through water; and a plurality of fasteners secured on the body for attaching one or more hooks and one or more lines to the fishing lure.

In accordance with another aspect of the disclosure, there is provided a fishing lure that is interconvertible between a self-propelled mode and a manual mode, the fishing lure comprising a watertight body housing a battery electrically connected via a controller to a coil, the coil positioned relative to a magnet, said coil oscillating in response to magnetic pole interactions between the coil and the magnet by virtue of a controller defined alternating current passing through the coil, the coil oscillation causing movement of a tail assembly that is engaged to the coil and the watertight body to cause the fishing lure to self-propel through water; and a first line fastener positioned on the dorsum of the fishing lure and a second line fastener positioned on the head of the fishing lure, the fishing lure attachable to a fishing line at the first line fastener when self-propelled through water and to the second line fastener when manually manipulated through water.

In accordance with a further aspect of the disclosure, there is provided a kit comprising the fishing lure according to the present disclosure, wherein the tail assembly comprises one or more interchangeable tail attachments each tail attachment shaped to resemble a different style of tail.

### BRIEF DESCRIPTION OF THE DRAWINGS

These and other features of the invention will become more apparent in the following detailed description in which reference is made to the appended drawings.

FIG. 1 is a side view of a fishing lure according to embodiments of the present disclosure, wherein the exterior of the fishing lure is shown;

FIG. 2 shows the interior of a fishing lure, according to embodiments of the present disclosure;

FIGS. 3A, 3B, 3C are side cross-sectional views of three variations of a fishing lure, according to embodiments of the present disclosure;

FIG. 4 is a close-up side cross-sectional view of the lipless fishing lure embodiment shown in FIG. 3A, according to embodiments of the present disclosure;

FIG. 5 is a close-up side cross-sectional view of the lipped fishing lure embodiment shown in FIG. 3B, according to embodiments of the present disclosure;

FIG. 6 is a close-up side cross-sectional view of the fishing lure shown in FIG. 3C illustrating an embodiment of an alternative tail shape, according to embodiments of the present disclosure;

FIG. 7 is a top cross-sectional view of the fishing lure, according to embodiments of the present disclosure; and

FIG. 8 is a top cross-sectional view of the fishing lure, according to embodiments of the present disclosure

### DETAILED DESCRIPTION OF THE INVENTION

A fishing lure according to embodiments of the present disclosure is motorized for self-propelled movement through the water to mimic the natural movement of live fish prey. The fishing lure of the present disclosure comprises a motorized tail assembly having a side-to-side oscillatory motion relative to the body of the fishing lure. The side-to-side oscillatory motion of the tail assembly propels the fishing lure through the water, and in some embodiments, the fishing lure can be caused to turn in a live fish-like manner. In some embodiments, the motor assembly of the present disclosure comprises a minimal number of moving parts to effect the movement of the fishing lure through the water. In this way, the noise level created by operation of the fishing lure is minimized to further mimic live fish prey.

The fishing lure, according to some embodiments, may comprise a tail assembly having an interchangeable tail. The interchangeability of the tail allows the fishing lure to be transformed into a variety of styles that resemble a variety of fish prey. According to such embodiments, the style of the fishing lure can be changed without having to cut and retie a lure to the line. In this way, the fishing lure of the present disclosure offers the user multiple options and versatility in the choice of fishing lure to use that best suits the fish being targeted.

According to certain embodiments of the present disclosure, the fishing lure may be dually operational between a self-propelled mode and a manual mode for controlling movement. In specific embodiments, for example, the shape of the fishing lure body and the buoyancy of the fishing lure may be modified to build in the specialized movement of the fishing lure. For example, the body of the fishing lure may be shaped as a plug lure such as a crankbait, wobbler, minnow, popper, shallow-diver, or deep-diver lure, that may comprise a lip to enable the fishing lure to dive to shallow or deep depths when manually propelled through the water. In this way, the movement of the fishing lure of the present disclosure may be controlled manually. Accordingly, such embodiments of the present disclosure offer the user the option to switch between a self-propelled fishing lure and a manually operated fishing lure.

### Self-Propelled Mode

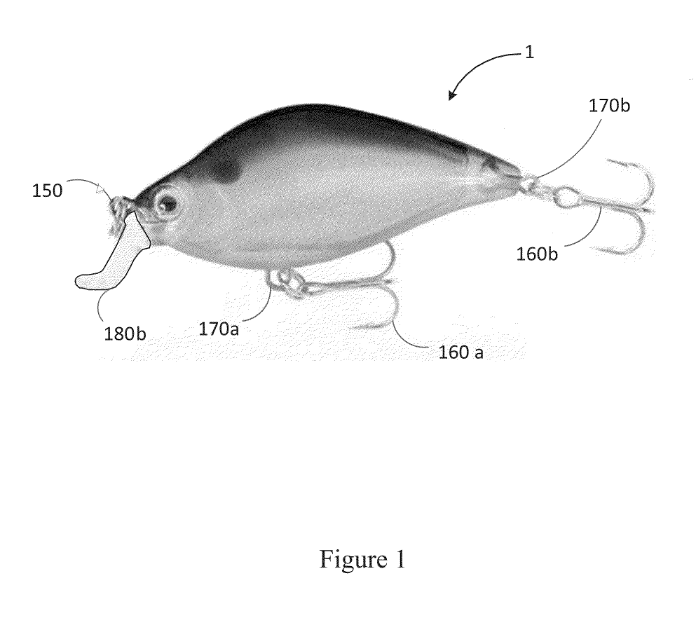

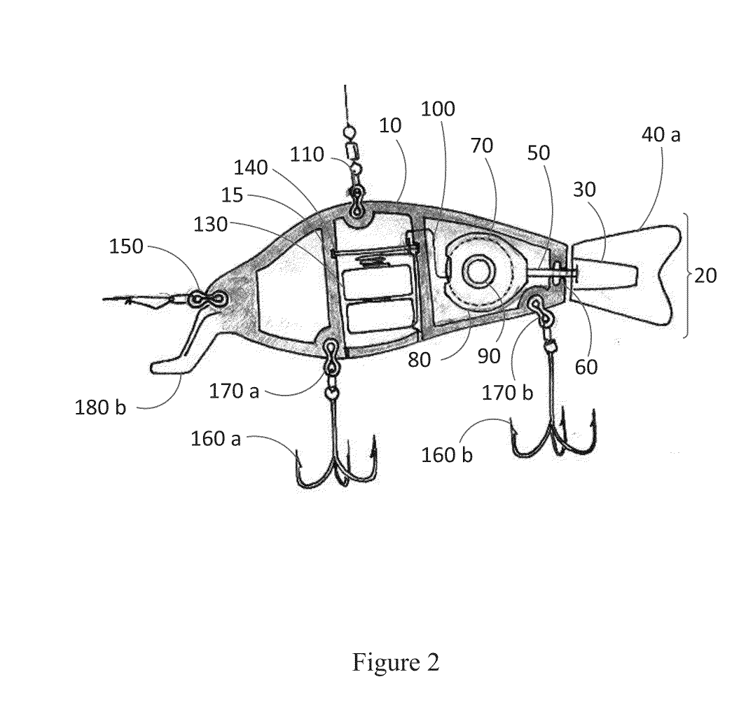

Referring to FIGS. 1 and 2 the fishing lure 1 of the present disclosure is of a buoyant configuration and motorized to allow it to self-propel through the water in a live fish-like movement. The fishing lure 1 comprises a body assembly 10 and a tail assembly 20. The tail assembly 20 is operably engaged with the body assembly 10 to allow coordinated movement through the water when in the self-propelled mode.

### Oscillating Movement

In the self-propelled mode (referring to FIGS. 2, 7 and 8), the tail assembly 20, is mechanically oscillated relative to the body 10 and thereby propels the fishing lure 1 through the water. The tail shaft 50, connected to the tail assembly 20, is driven by a motor to cause the tail assembly 20 to oscillate. The tail-free end of the tail shaft 50, enters the body cavity and is operatively connected to the motor housed within the body assembly 10.

The motor, according to embodiments of the present disclosure, is an electromagnetic motor comprising a magnet 90 secured within the body assembly 10 and oriented to allow alternating interaction with an energizable coil 70. The energizable coil 70 is connected to the tail shaft 50 to cause the tail shaft 50 to oscillate with the alternating interaction of the coil 70 with the magnet 90. The coil 70 is electrically connected 100 to a battery 130 and a controller 120 to control the direction of current through the coil 70 and thus the magnetic polarity of the coil 70. For example, when the coil 70 is energized, magnetic poles are induced in the coil 70 and these magnetic poles interact with the magnetic poles of the magnet 90. Specifically, in such embodiments, the magnet 90 will generate an attraction force when the coil 70 is energized with a first current, and a repelling force when the coil 70 is energized with a reversed second current. In this way, alternating the direction of the current causes the generated force between the energized coil 70 and the magnet 90 to also alternate, thereby causing the attached tail shaft 50 to oscillate.

It is contemplated that persons of skill in the art will recognize that a conventional electric motor with gear box or a linear actuator motor may be used in place of an electro-magnetic coil motor to drive the tail shaft 50. Such embodiments are also included in the present disclosure.

### Mechanical Tail Assembly

Again referring to FIG. 2, the tail assembly 20 comprises a rudder 30 to which a tail attachment 40a is attached. The rudder 30 provides a supporting structure for the tail attachment 40a which is attached overtop of the rudder 30. A tail shaft 50 connects to the tail assembly 20 at the rudder 30 and, as shown in FIG. 2, the opposite free end of the tail shaft 50 enters the body assembly 20 through an opening at the tail end of the body assembly 10 to connect the tail assembly 20 to the body assembly 10. In order to maintain a watertight body cavity, the entry of the tail shaft 50 into the cavity of the body assembly 10 is sealed. In one embodiment, the seal is provided by a sealing ring 60.

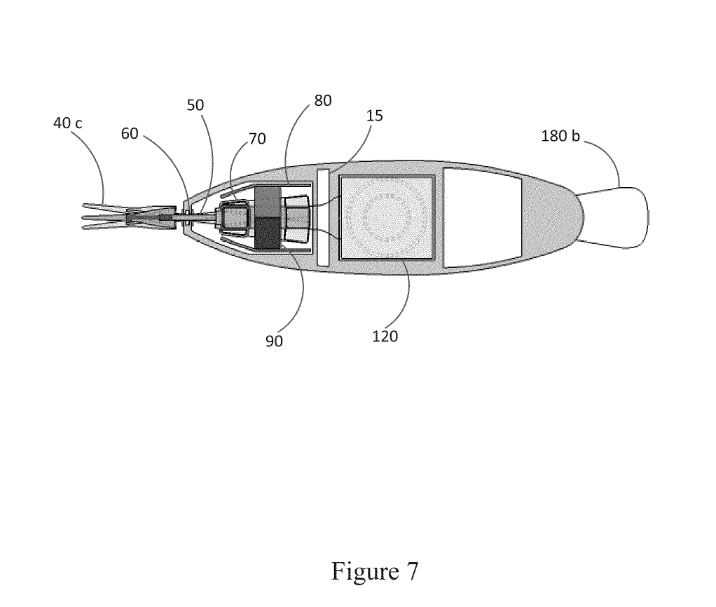

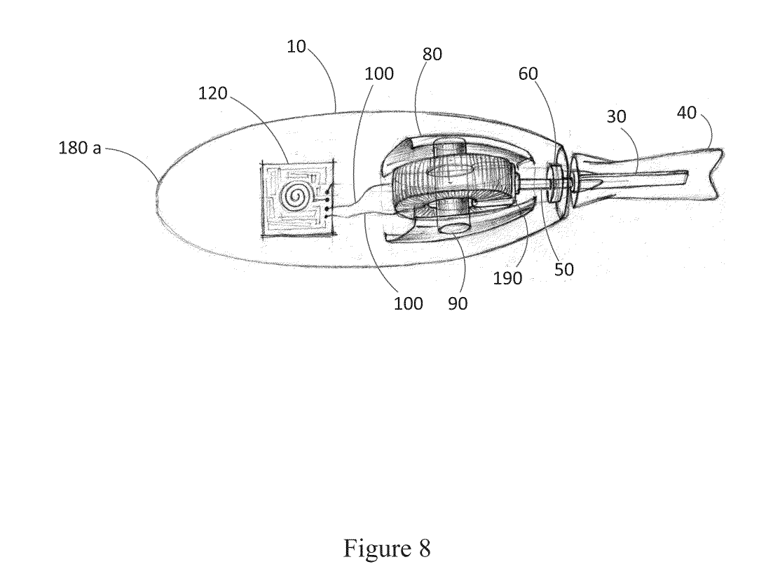

As shown in FIGS. 7 and 8, the tail shaft 50 enters the inner cavity of the body assembly 10 and is attachably mounted to an electromagnet coil 70. In one embodiment, the tail shaft 50 comprises a mounting bracket 190 to retain the coil 70 in place within the body assembly 10 and to operatively connect the coil 70 to the tail assembly 20 as will be discussed below.

A magnet 90 having opposing magnetic poles is secured within the body assembly 10 such that the coil 70 and magnet 90 cooperatively interact to effect oscillation of the tail assembly 20. In a preferred embodiment, the magnet 90 is secured within the body assembly 20 by a holding bracket 80 on either side of the coil 70 such that the central axis of the magnet 90 is disposed perpendicular to the central axis of the coil 70. In one embodiment, the coil 70 is toroidal and the magnet 90 is disposed perpendicularly through the toroid.

In use, when the coil 70 is energized the magnetic poles formed in the coil 70, cause either an attraction or repelling force between the coil 70 and the magnet 90. Alternating these forces between the coil 70 and the magnet 90 causes the coil 70 to correspondingly move which translates through the connected tail shaft 50 to ultimately cause the tail assembly 20 to oscillate. It will be apparent to those of skill in the art that the magnet and coil configuration may be different, but have the same effect.

### Power Assembly

The coil 70 is electrically connected 100 to a power assembly situated within the body assembly 10. The power assembly comprises a battery 130 and a controller or control circuit 120. In one embodiment (FIG. 2), the power assembly is secured within the body assembly 10 by a supporting scaffold 15 to ensure that the power assembly is centrally contained within the body assembly 10. In this way, the weight of the fishing lure remains balanced and movement of parts within the body assembly 10 is prevented.

As discussed above, the movement of the tail assembly 20 can be controlled by the alternating interaction of the coil 70 with the magnet 90. Thus, the direction that the fishing lure 1 moves can be changed by varying the current direction through the coil 70. For example, as will be apparent to those skilled in the art, the current pulses can be varied in direction, duration, amplitude, or by applying an offset sine wave current pulse to the coil 70. In this way, the movement of the fishing lure 1 can be controlled.

In one embodiment, the controller 120 comprises a PCB and an on/off switch (not shown). In some embodiments, the controller 120 can further comprise an LED indicator light capable of showing the status of activation of the fishing lure 1 or charging of the fishing lure 1.

In some embodiments, the battery 130 is rechargeable. For example, the body assembly 10 can comprise a watertight port and a charge socket for connecting to a suitable charging plug.

### Manual Mode

According to embodiments of the present disclosure, the fishing lure 1 is dually operational between the self-propelled mode discussed above and a manual mode. When in the self-propelled mode, the fishing lure 1 relies less on the skill of the angler to manipulate the lure through the water in a manner that mimics natural prey. The angler merely needs to switch on the power, to activate the oscillating movement of the tail assembly 20, and direct the rod with the attached fishing line to where he wishes to fish. In this way, the self-propelled mode allows the angler to fish hands-free if desired by securing the rod to a stationary rod holder. At any time, the angler may use the fishing lure 1 in a manual mode. In one embodiment, the weight distribution and balance of the fishing lure 1 is designed to allow the fishing lure 1 to be used in a manual cast and retrieve manner by the angler. In other embodiments, the fishing lure 1 is adapted to allow positioning of the fishing line to facilitate manual casting and retrieving of the fishing lure 1.

When used in the manual mode, the fishing lure 1 can remain in its activated state (power on state) such that the fishing lure 1 has self-propelled movement during retrieval by the angler. In other embodiments, the fishing lure 1 can be deactivated by switching the power off for use in its manual mode.

When used in the self-propelled mode, it is preferred to attach the fishing lure 1 to the fishing line at a central point on the dorsum of the fishing lure 1. Referring to FIG. 2, this centrally located line fastener 110 ensures that the fishing lure 1 is balanced on the line to allow it to move in a natural prey-like manner.

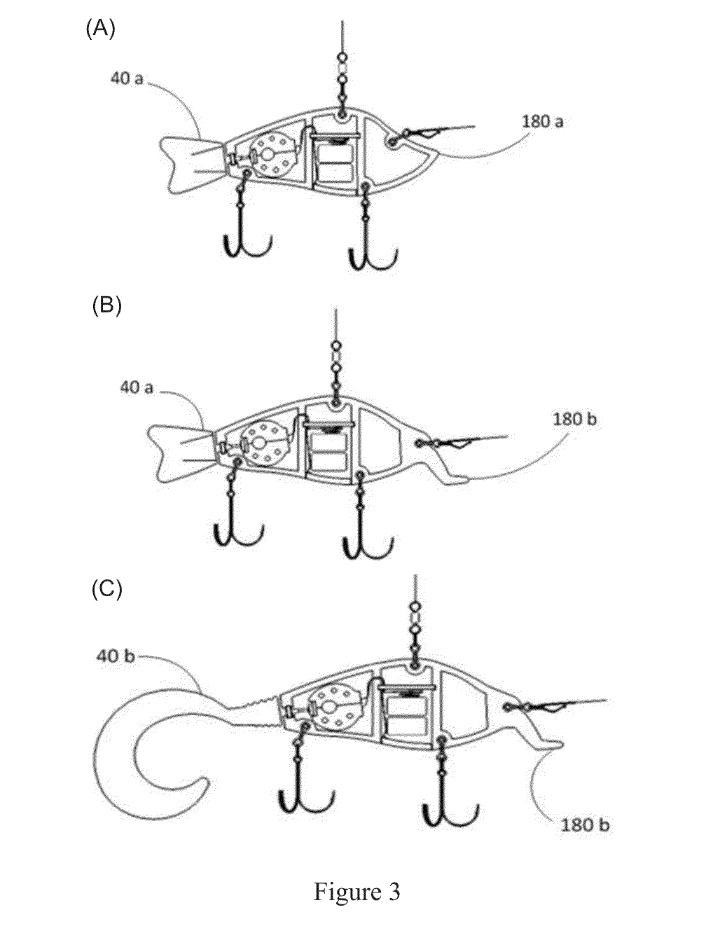

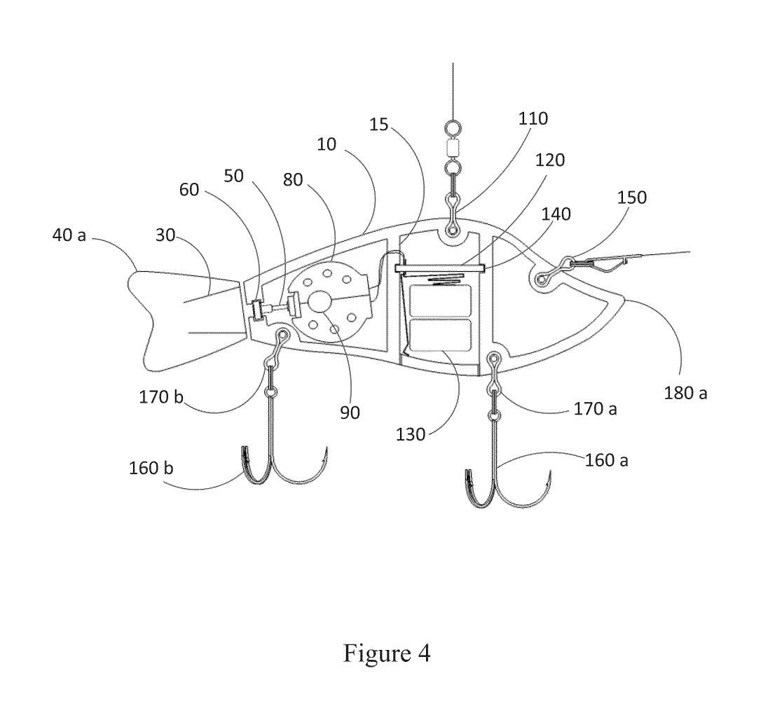

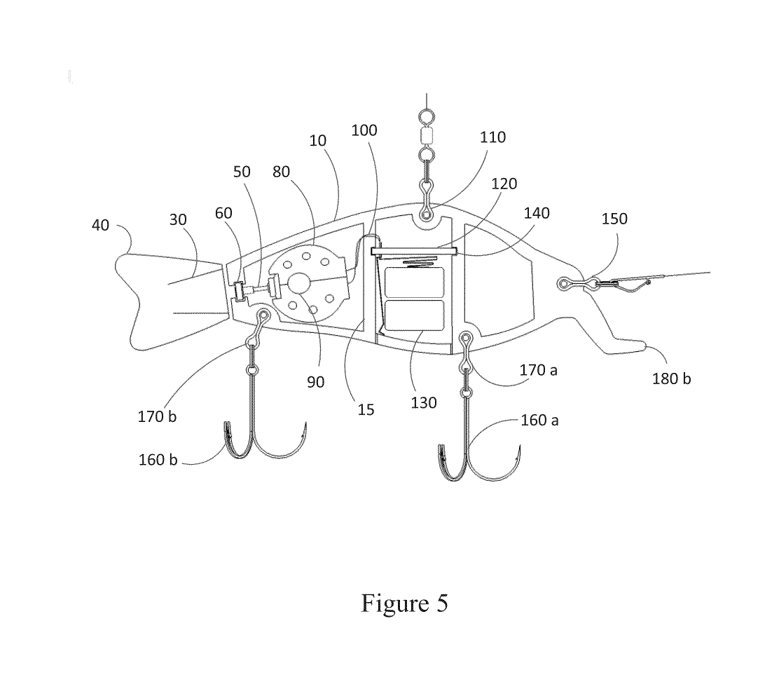

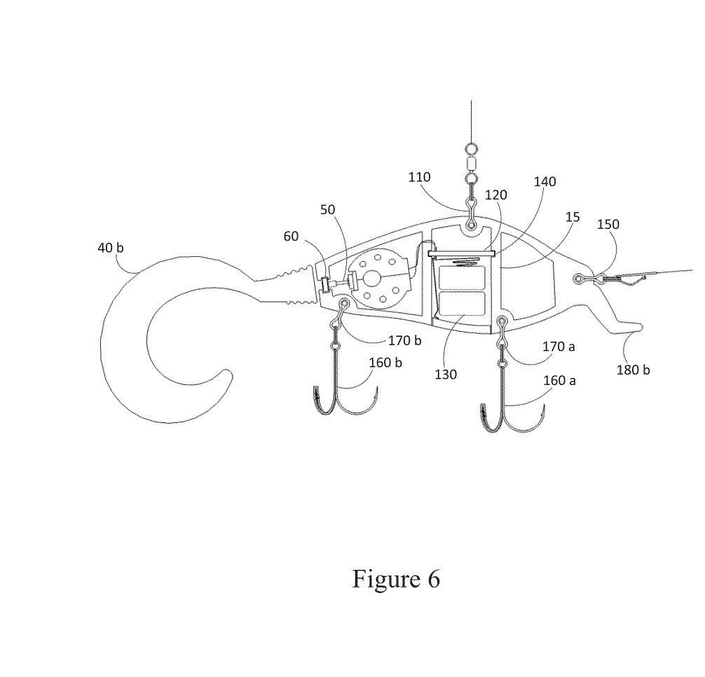

Manually operated fishing lures, however, require the angler to manipulate the lure through the water. The shape of the fishing lure can be designed to cause the lure to move a certain way in the water when manually cast and retrieved by an angler. Accordingly, certain embodiments of the present disclosure include fishing lures 1 in which the body assembly 10 is designed to move enticingly through the water when used in the manual mode. For example, the fishing lure 1 according to some embodiments, can be shaped as a plug lure. In other embodiments, the fishing lure 1 can be shaped as a lipless crankbait lure (FIGS. 3A and 4). In further embodiments, the fishing lure 1 can be shaped as lipped crankbait lure having a lip 180b extending from its head (FIGS. 3B, 3C, 5 and 6). To successfully manipulate such embodiments through the water, the fishing lure 1 according to some embodiments can be drawn by its head as opposed to its dorsum. Accordingly, the fishing lure 1 according to some embodiments, can be adapted for connection to a fishing line at its dorsum, for use in the self-propelled mode, as well as for connection at its head, for use in the manual mode.

In certain embodiments, the fishing lure 1 of the present disclosure comprises a plurality of fasteners 170a, 170b, 110, 150 secured on the body assembly 10 for attaching hooks 160a, 160b and/or lines and/or weights to the fishing lure 1. In some embodiments, the fishing lure 1 comprises a single line fastener 110 positioned on the dorsum of the fishing lure 1 and attachable to a fishing line when in the self-propelled mode. In other embodiments the fishing lure 1 comprises two line fasteners 110, 150, a first line fastener 110 positioned on the dorsum of the fishing lure 1 and attachable to a fishing line when in the self-propelled mode, and a second line fastener 150 positioned on the head of the fishing lure 1 and attachable to a fishing line when in the manual mode. In further embodiments the fishing lure 1 comprises two or more line fasteners 110, 150. For example, in such embodiments, a first line fastener 110 can be positioned on the dorsum for use in the self-propelled mode, a second line fastener 150 can be positioned on the head for use in the manual mode, and a third line fastener can be positioned on the lip 180b of the lure to provide the option of attaching the line at a distance from the body in the manual mode. In dual mode embodiments, therefore, the angler can quickly reposition the fishing line to the desired line fastener and, in this way, convert the fishing lure 1 from a self-propelled lure to a manual lure and vice versa.

In addition to the one or more line fasteners 110, the fishing lure 1 of the present disclosure comprises one or more hook fasteners 170a, 170b for attaching one or more hooks 160a, 160b. The hook fasteners 170a, 170b can be positioned anywhere on the body assembly 10. In some embodiments, one or more hook fasteners 170a, 170b can be positioned on the ventrum of the lure body. In other embodiments, one or more hook fasteners (not shown) can be positioned on the dorsum of the lure body. In further embodiments, one or more hook fasteners can be positioned on the dorsum and the ventrum 170a, 170b of the lure body.

### Interchangeable Form

As shown in FIGS. 3A, 3B, 3C, and 7, for example, the fishing lure 1, according to some embodiments, may comprise a tail assembly 20 having an interchangeable tail attachment 40a, 40b, 40c. The interchangeability of the tail attachment 40a, 40b, 40c allows the fishing lure 1 to be transformed into a variety of styles that resemble a variety of fish prey. According to such embodiments, the style of the fishing lure 1 can be changed without having to cut and retie a lure to the line. In this way, the fishing lure 1 of the present disclosure offers the user multiple options and versatility in the choice of fishing lure to use that best suits the fish being targeted.

The tail attachment 40a, 40b, 40c can take the shape of any number of tail styles known in the art. For example, the tail attachment 40a, 40b, 40c according to some embodiments can be shaped to resemble a fish tail 40a (FIG. 3A), a grub tail 40b (FIG. 3C), a mouse tail, a beaver tail, a worm tail, a split tail 40c (FIG. 7), an octopus style tail, or any commercially available style of fishing lure tail. The tail attachment 40a, 40b, 40c is releasably attachable to the rudder 30. For example, the tail attachment 40a, 40b, 40c and rudder 30 can matingly attach by way of a screw-type attachment means. In other embodiments, the tail attachment 40a, 40b, 40c can fittingly slide over the rudder 30 in a secure manner.

The body assembly 10 of the fishing lures 1 of the present disclosure can be manufactured from any resilient, water-resistent material. For example, the body assembly 10 according to some embodiments can be made from polycarbonates or plastics. In some embodiments, the tail attachment 40a, 40b, 40c can be made from the same material as the body assembly 10. In other embodiments, the tail attachment 40a, 40b, 40c can be made from a more pliable material including, for example, plastic or rubber. The body assembly 10 can also be decorated, patterned, or painted to further resemble fish prey or to better attract fish.

It is further contemplated that the buoyancy of the fishing lures of the present disclosure can be adapted by attaching weight to the lure. For example, in accordance with certain embodiments, one or more weights can be attached to the fishing lure 1 to adjust the lure to the desired buoyancy. Such weights can, for example, be attached to any one of the fasteners 170a, 170b. In other embodiments, weights can be inserted into the body cavity of the fishing lure 1.

### Kits

The present disclosure additionally provides for kits comprising a fishing lure 1 of the present disclosure comprising one or more interchangeable tails and/or one ore more attachable weights. Interchangeable replacement tails and/or buoyancy weights could be individually packaged separately.

To gain a better understanding of the invention described herein, the following examples are set forth. It will be understood that these examples are intended to describe illustrative embodiments of the invention and are not intended to limit the scope of the invention in any way.

The disclosures of all patents, patent applications, publications and database entries referenced in this specification are hereby specifically incorporated by reference in their entirety to the same extent as if each such individual patent, patent application, publication and database entry were specifically and individually indicated to be incorporated by reference.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

The embodiments of the invention in which an exclusive property or privilege is claimed are defined as follows:

1. A fishing lure, comprising a watertight body housing a battery electrically connected via a controller to a coil, the coil positioned relative to a magnet, said coil oscillating in response to magnetic pole interactions between the coil and the magnet by virtue of a controller defined alternating current passing through the coil, the coil oscillation causing movement of a tail assembly that is engaged to the coil and the watertight body to cause the fishing lure to self-propel through water.

2. The fishing lure according to claim 1, wherein the magnet is presented with its polarity oriented towards the coil in a manner to make the magnet generate an attraction force when the coil is energized with a first current, and a repelling force when the coil is energized with a reversed second current.

3. The fishing lure according to claim 2, wherein energization of the coil is controlled by the controller by altering the direction of current through the coil and thus the magnetic polarity of the coil.

4. The fishing lure according to claim 1, wherein the tail assembly comprises a tail shaft connected to the coil to cause the tail shaft to oscillate with the oscillation of the coil thereby causing movement of the tail assembly.

5. The fishing lure according to claim 4, wherein the tail assembly further comprises a rudder that is connected to the tail shaft, the rudder further supporting a tail attachment that is attachable overtop of the rudder.

6. The fishing lure according to claim 5, wherein the tail attachment is shaped to resemble a fish tail, a grub tail, a mouse tail, a beaver tail, a worm tail, a split tail, an octopus style tail, or any commercially available style of fishing lure tail.

7. The fishing lure according to claim 6, wherein ail attachment is interchangeable.

8. The fishing lure according to claim 1, further comprising a plurality of fasteners secured on the body for attaching one or more hooks and one or more lines to the fishing lure.

9. The fishing lure according to claim 8, wherein the plurality of fasteners comprises a first line fastener positioned on the dorsum of the fishing lure, the fishing lure attachable to a fishing line at the first line fastener when in a self-propelled mode.

10. The fishing lure according to claim 9, wherein the plurality of fasteners further comprises a second line fastener positioned on the head of the fishing lure, the fishing lure attachable to the fishing line at the second line fastener when in a manual mode.

11. The fishing lure according to claim 1, wherein the fishing lure is shaped as a popper.

12. The fishing lure according to claim 1, wherein the fishing lure is shaped as a plug lure.

13. The fishing lure according to claim 12, wherein the plug lure is a lipless crankbait lure.

14. The fishing lure according to claim 12, wherein the plug lure is a lipped crankbait lure.

15. The fishing lure according to claim 14, wherein a first line fastener is positioned on the dorsum of the fishing lure and a second line fastener is positioned on the crankbait lip, the fishing lure attachable to a fishing line at the first line fastener when in a self-propelled mode and to the second line fastener when in a manual mode.

16. The fishing lure according to claim 8, wherein the plurality of fasteners comprises one or more hook fasteners positioned on the ventrum of the fishing lure.

17. A fishing lure that is interconvertible between a self-propelled mode and a manual mode, the fishing lure comprising:
a watertight body housing a battery electrically connected via a controller to a coil, the coil positioned relative to a magnet, said coil oscillating in response to magnetic pole interactions between the coil and the magnet by virtue of a controller defined alternating current passing through the coil, the coil oscillation causing movement of a tail assembly that is engaged to the coil and the watertight body to cause the fishing lure to self-propel through water; and
a first line fastener positioned on the dorsum of the fishing lure and a second line fastener positioned on the head of the fishing lure, the fishing lure attachable to a fishing line at the first line fastener when self-propelled through water and to the second line fastener when manually manipulated through water.

18. The fishing lure according to claim 17, wherein the fishing lure is shaped as a popper.

19. The fishing lure according to claim 17, wherein the fishing lure is shaped as a lipless crankbait lure.

20. The fishing lure according to claim 17, wherein the fishing lure is shaped as a lipped crankbait lure.

21. The fishing lure according to claim 20, wherein the second line fastener is positioned on the lip of the lipped crankbait lure.

22. The fishing lure according to claim 17, wherein the tail assembly comprises a tail attachment shaped to resemble a fish tail, a grub tail, a mouse tail, a beaver tail, a worm tail, a split tail, an octopus style tail, or any commercially available style of fishing lure tail.

23. The fishing lure according to claim 22, wherein the tail attachment is interchangeable.

24. The fishing lure according to any one of claims 1 to 23, wherein the battery is rechargeable.

25. The fishing lure according to claim 24, wherein the body further comprises a watertight port and a charge socket for connecting to a suitable charging plug to recharge the battery.

26. The fishing lure according to any one of claims 1 to 25, wherein the body is decorated, patterned, or painted to resemble fish prey.

27. The fishing lure according to any one of claims 1 to 26, further comprising one or more weight to adjust the buoyancy of the lure.

28. The fishing lure according to any one of claims 1 to 27, further comprising one or more LED indicator light.

29. The fishing lure according claim 28, wherein the indicator light signals the status of activation of the fishing lure.

30. The fishing lure according to claim 28, wherein the indicator light signals the battery charge of the fishing lure.

31. A kit comprising the fishing lure according to claim 1 or 17, wherein the tail assembly comprises one or more interchangeable tail attachments each tail attachment shaped to resemble a different style of tail.

32. The kit according to claim 31, wherein the one or more interchangeable tail attachments is shaped to resemble a fish tail, a grub tail, a mouse tail, a beaver tail, a worm tail, a split tail, an octopus style tail, or any commercially available style of fishing lure tail.
